(19) United States
(12) Patent Application Publication
(10) Pub. No.: US 2014/0203091 A1
(43) Pub. Date: Jul. 24, 2014

(54) PORTABLE DIGITAL THERMOSTAT

(71) Applicant: Unnikrishnan Ramachandran Nair, Fairfax Station, VA (US)

(72) Inventor: Unnikrishnan Ramachandran Nair, Fairfax Station, VA (US)

(21) Appl. No.: 13/904,894

(22) Filed: May 29, 2013

Related U.S. Application Data
(60) Provisional application No. 61/756,448, filed on Jan. 24, 2013.

(51) Int. Cl. G05D 23/19

(52) U.S. Cl. CPC G05D 23/1905; G05D 23/1917
USPC 236/51

(57) ABSTRACT

Portable Digital Thermostat, consist of a base unit suitable for wall mounting in a location suitable for such purpose in a manner similar to a conventional thermostat. Included in the system is a conventional rechargeable battery powered remote control unit that incorporates all aspects of a modern digital thermostat, including programming functions, clock, displays, controls and sensors. Designed to promote energy conservation and climate control where needed, this invention allow repositioning of the remote control unit any where within the building. The remote control unit allows automatic control of the HVAC system based on the temperature at any selected location without the hassle of rewiring and repositioning the base unit.

### CROSS REFERENCE TO RELATED APPLICATION

This application claims the benefit of provisional patent application Ser. No. 61/756,448, filed 2013 Jan. 24 by the present inventor.

### STATEMENT REGARDING FEDERALLY SPONSORED RESEARCH OR DEVELOPMENT

Not Applicable

Description of Attached Appendix Not Applicable

### BACKGROUND OF THE INVENTION

The present invention relates to digital thermostats, more specifically to portable programmable digital thermostats used in heating ventilating and air conditioning (HVAC) systems which allows the user to relocate the said thermostat anywhere in the house without rewiring the system.

Digital thermostats are commonly used in residential, commercial and industrial buildings to control the operation of an HVAC system. Typically these thermostats are mounted on a wall and connected by electrical circuitry to the controller located within the HVAC unit. The location of the thermostat is chosen at the time of the construction and based on information available to the installer at that time. Sensors located within the thermostat measures the ambient temperature and compare it to the set temperature to determine if it is time to turn the unit on or off.

Newer homes are significantly larger than older homes and typically have many rooms that are unoccupied. In an effort to save on the cost of heating and air conditioning a typical homeowner will shut off the vents in these rooms and close the doors to these rooms when they are not in use. If the thermostat is located in one of the rooms that are unoccupied, then the home owner is unable to turn off the vents in the said room. He is also unable to maintain the temperature in the room which is frequently used to his comfort level since the system is controlled by the thermostat in another room or area. The permanent location of the thermostat may also be questionable at a later date based on location of furniture, drapes and other items which effect air movement around the thermostat. Moving the position of the thermostat to a different room or area based on the occupancy of the room or the décor is both expensive and difficult. In the current age of energy efficiency and responsible energy usage, a system that controls the comfort level where it is needed the most is ideal.

A search of the prior art did not disclose any patents that read directly to the claims of this invention; however the following references are considered related:

| | | | |
|---|---|---|---|
| 4336902 | A | 1982-06-29 | Neal |
| 4353502 | A | 1982-10-12 | Myers |
| 4433719 | A | 1984-02-28 | Cherry et al. |
| 4682648 | A | 1987-07-28 | Fried |
| 4969508 | A | 1990-11-30 | Tate et al. |
| 5224353 | A | 1993-07-06 | Nagasawa |
| 5272477 | A | 1993-12-21 | Tashima et al. |
| 5361982 | A | 1994-11-08 | Liebl et al. |
| 6394359 | B1 | 2002-05-28 | Morgan |

Of some relevance is U.S. Pat. No. 6,394,359 issued to Morgan. The invention if the '359 reference is a remote control thermostat which gives the user the ability to change the preset temperature over radio frequency signals. Although there is a temperature sensor in the remote control unit, it is only used to measure and display the ambient temperature at the remote control unit. The HVAC system is still controlled based on the temperature sensor within the base unit located on the wall and connected to electrical circuits to the HVAC controller. This invention does not provide the ability to automatically control the comfort level in the room which is frequently occupied which help conserve energy and improve occupant comfort.

Of considerable relevance is U.S. Pat. No. 4,433,719 issued to Cherry et al. The invention of the '719 reference is a portable analog thermostat which controls the heating and cooling cycle over radio frequency signals. This invention is neither programmable nor digital and lacks the ability to control the heating and cooling cycles based on time of day or day of the week. This invention is also powered by a conventional battery and will render the system useless if the battery is completely discharged. There is also the possibility of misplacing the remote which affects the ability to control the HVAC system. The present invention eliminates these problems.

### SUMMARY OF THE INVENTION

The primary object of the present invention is to provide a portable and programmable digital remote control thermostat.

Another object of the present invention is to use the existing wiring and location available within the building for the base unit, similar to a conventional thermostat.

Another object of the present invention is to provide full control of the thermostat using the remote control unit.

A further object of the present invention is to control the HVAC unit for anywhere within the building.

Yet another object of the present invention is to control the HVAC unit based on the temperature measured at the remote control unit.

Still yet another object of the present invention is to conserve energy by minimizing heating and cooling rooms that are unoccupied.

Another object of the present invention is to use conventional rechargeable batteries in the remote control unit.

Another object of the present invention is to provide the ability to recharge the remote control unit when it is placed in the wall mounted base unit or on the remote battery charging station.

A further object of the present invention is to provide the ability to locate a misplaced remote control unit from the wall mounted base.

Yet another object of the present invention is to provide a flip-up stand to place the remote control unit on a table or other flat surface.

Still yet another object of the present invention is to provide an alert if the battery in the remote control unit is running low.

Another object of the present invention is to provide an alert if the remote control unit is unable to communicate with the base unit.

Another object of the present invention is to provide an alert if system troubles are identified with the HVAC system or the thermostat.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, a Portable Digital Thermostat, briefly described here, consist of a base unit suitable for wall mounting in a location suitable for such purpose in a manner similar to a conventional thermostat. Included in the system is a rechargeable battery powered remote control unit that incorporates all aspects of a modern digital thermostat, including programming functions, clock, displays, controls and sensors. Designed to promote energy conservation and climate control where needed, this invention allow repositioning of the remote control unit any where within the building. The remote control unit allows automatic control of the HVAC system based on the temperature at any selected location without the hassle of rewiring and repositioning the base unit. The remote control unit communicates wirelessly with the base unit. A buzzer is available in the remote control unit to alert the user of its inability to communicate to the base, trouble detected in the system, or to locate a misplaced remote with the push button located on the base unit. Also included in this system is a remote battery charging station that can be used to recharge the battery present in the remote control unit and a flip-up stand on the remote control unit to position it upright on a table.

### DESCRIPTION OF THE DRAWINGS

FIG. 1 is a perspective view of the remote control unit and the wall mountable base unit, according to the preferred embodiment of the present invention.

FIG. 2 is an elevation view of the remote control unit installed in the wall mountable base unit, according to the preferred embodiment of the present invention.

FIG. 3 is an elevation view of the rear of the remote control unit and the wall mountable base unit, according to the preferred embodiment of the present invention.

FIG. 4 is an elevation view of the remote control unit installed in the remote charging station, according to the preferred embodiment of the present invention.

FIG. 5 is a flow diagram of the operations of the portable digital thermostat according to the preferred embodiment of the present invention.

FIG. 6 is an elevation view of the front of the remote control unit, according to the additional embodiment of the present invention.

FIG. 7 is an elevation view of the rear of the remote control unit, according to the additional embodiment of the present invention.

Drawings - Reference Numerals

| | |
|---|---|
| 101 | base unit |
| 102 | remote control unit |
| 103 | display |
| 104 | battery charging terminal |
| 105 | battery charging contact |
| 106 | multipurpose keypad |
| 107 | ridge or tongue |
| 108 | slot or groove |
| 109 | buzzer |
| 110 | flip stand |
| 111 | remote charging station |
| 112 | remote locator |
| 113 | touch sensitive display |
| 114 | wall mount |
| 213 | first functional block |
| 214 | first operational block |
| 215 | second functional block |
| 216 | third operational block |
| 217 | third functional block |
| 218 | forth functional block |
| 219 | forth operational block |
| 220 | fifth operational block |
| 221 | sixth operational block |
| 222 | fifth functional block |
| 223 | seventh operational block |
| 224 | eighth operational block |
| 225 | ninth operational block |
| 226 | sixth functional block |
| 227 | seventh functional block |

### DETAILED DESCRIPTION OF THE PREFERRED EMBODIMENT

Detailed description of the preferred embodiment is provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

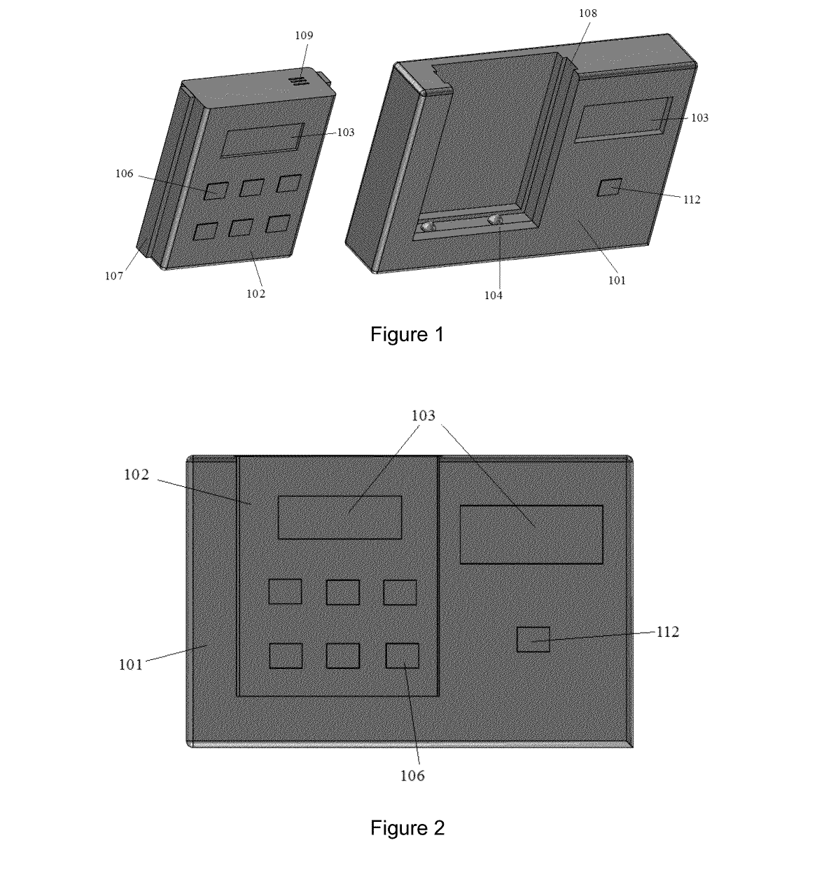

In accordance with the present invention, FIG. 1 show a perspective view of the portable remote control unit 102 and a wall mountable base unit 101 which can be mounted on the wall instead of a conventional thermostat using existing wiring. The base unit 101 is similar to a conventional wall mountable thermostat but without the temperature sensing function, and user switches necessary to program the thermostat and to control the temperature. Base unit 101 is equipped with a transceiver that connects and communicates wirelessly over the air to the remote control unit 102. Remote control unit 102 has the temperature sensing circuitry along with user controls available in a conventional digital programmable thermostat. Remote control unit 102 is equipped with a transceiver that connects and communicates wirelessly over the air to the base unit 101. The remote control unit 102 will measure and compare the ambient temperature to the preset temperature set by the user in real-time. If the ambient temperature is above or below the set temperature, the remote control unit 102 will communicate with the base unit to raise or lower the temperature to maintain the desired temperature at the remote control unit. The remote control unit 102 and the base unit 101 is equipped with a display 103 which shows the day, date and time, ambient temperature, set temperature and other parameters. The base unit 101 has two battery charging terminals 104 which are recessed within the groove 108 to prevent accidental shorting of terminals. The remote control unit 102 has two battery charging contacts 105 which come in contact with the battery charging terminals 104 when the remote control unit is installed in the base unit 101. The base unit 101 has a groove 108 or slot and the remote control unit 102 has a ridge 109 or tongue. This ensures that the remote control unit 102 is installed easily and securely on the base unit 101. The remote control unit 102 is equipped with a keypad 106 which is used to program the thermostat and to override a preset setting. Individual heating and cooling schedules can be entered using the keypad 106, as well as configuring the current date and time. The entries are stored within the remote control unit 102. The remote control thermostat 102 is also equipped with a buzzer 109 that can be activated by a single key 112 located on the base unit 101. This audible buzzer 109 is activated remotely to locate a lost or misplaced remote control unit 102. The buzzer 109 is also used to generate an alert tone if the battery is low, the base unit cannot be reached over the air, or if errors condition is detected with the HVAC unit or the thermostat.

In accordance with the present invention, FIG. 2 is a front view of the remote control unit 102 installed in the wall mountable base unit 101. The remote control unit 102 is placed on the base unit 101 to charge its internal rechargeable batteries. It can also be placed on the base unit 101 if the location of the thermostat is ideal at the location where electrical wiring from the HVAC unit is available.

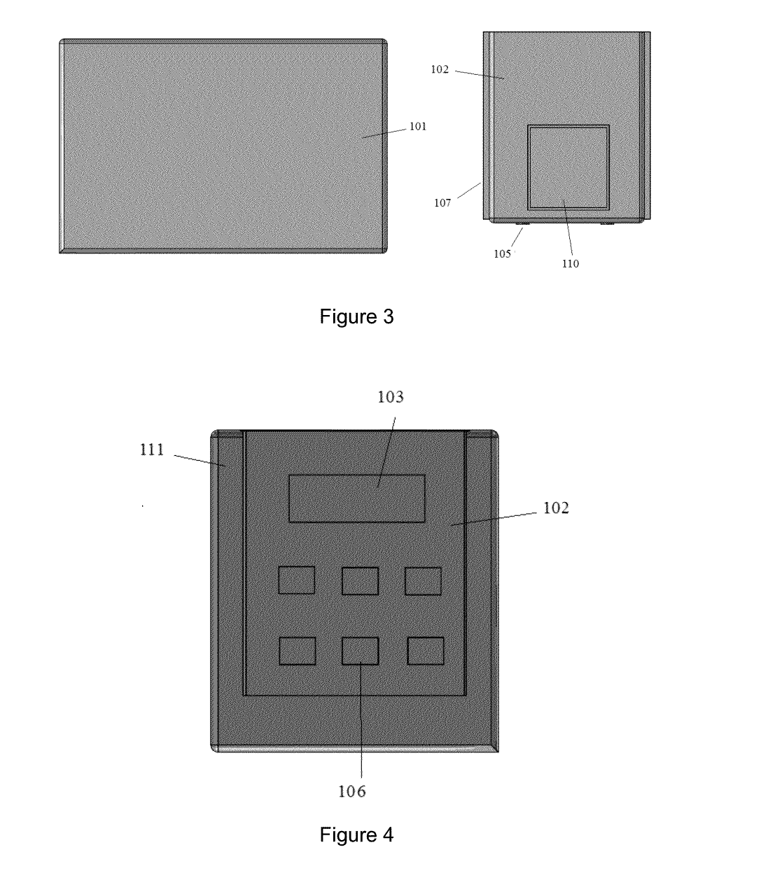

FIG. 3 is a rear view of the remote control unit 102 and the wall mountable base unit 101, according to the preferred embodiment of the present invention. This figure illustrates the two battery charging contacts 105 which come in contact with the battery charging terminals 104 when the remote control unit 102 is installed in the base unit 101. It also shows the flip stand 110 which is used to place the unit on any flat surface.

FIG. 4 is a front view of the remote control unit 102 installed in the remote charging station 111, according to the preferred embodiment of the present invention. The remote charging station 111 helps to charge the remote control unit 102 without returning it to the base unit 101. Leaving the unit on the remote charging station 111 will ensure that the internal rechargeable batteries are always charged. This charging station is powered by a power supply connected to any standard wall outlet.

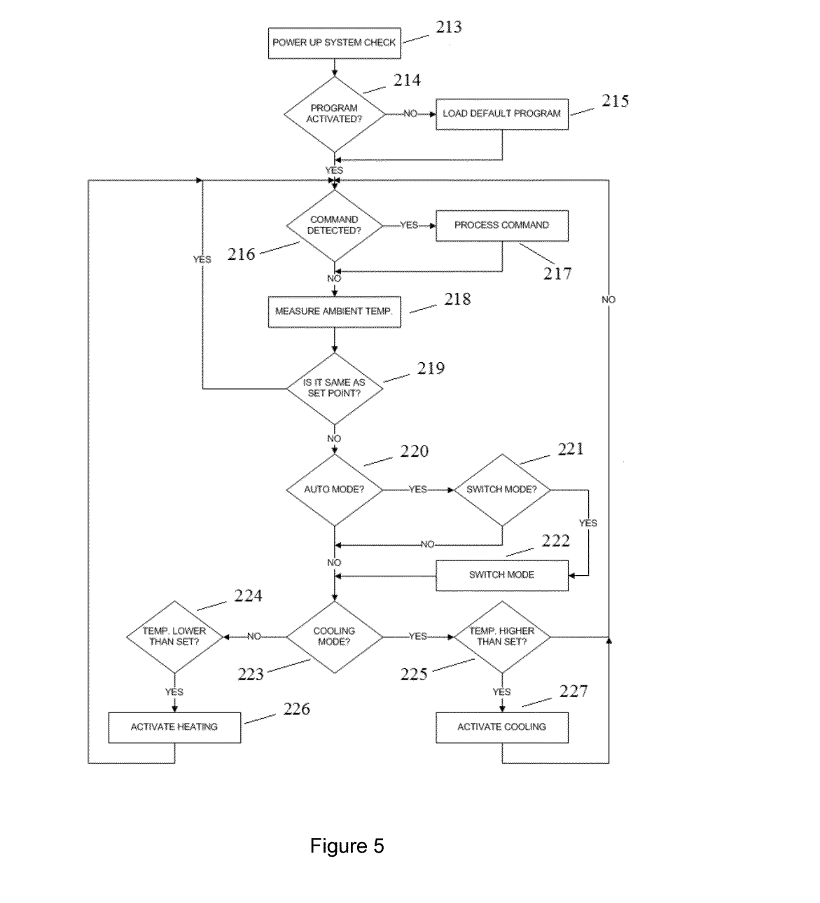

FIG. 5 is a flow diagram describing the operation of the portable digital thermometer. This flow diagram depicts of logical operation of the remote control unit 102. The process begins with the functional block 213, when the remote control unit 102 is tuned on. The system performs a power-on self check where the software and all hardware elements are checked. The next operational block 214 is when the software checks to see if the remote control unit 102 was previously configured and that an active program was selected. On a positive feedback, the control is transferred to the next operation block 216 where the unit checks to see if local keypad 106 entries or a command over the air from the base unit 101 was received. If an entry or a command is detected, the remote control unit 102 analyses the information provided and takes the necessary action. On a negative feedback, the system checks the mode selected and loads the appropriate preset schedule in the functional block 215. In the next functional block 218 the ambient temperature at the remote control unit 102 is measured, and is compared against the set temperature in the next operational block 219. If the difference in temperature is less than the configured acceptable swing, the logical flow is transferred to the operational block 214 and the process continues. Any active heating or cooling cycle is terminated at this point. On a positive feedback, if the temperature difference is greater than the configured acceptable swing, the control goes to operational block 220 where the operational mode is checked. If the system is in manual mode, logical control is transferred to the operational block 223 where it is determined if the system is in heating mode or cooling mode. If the system is in Auto mode, then the logical control is passed to the operation block 221 where the decision to switch the mode is made depending on the difference in temperature. If the measured temperature is higher than the set temperature by a substantial margin and if the system is in heating mode, the mode is switched from heat to cool automatically in the functional block 222. If on the other hand, the measured temperature is lower than the set temperature by a substantial margin and if the system is in cooling mode, the mode is switched from cool to heat automatically in the functional block 222. Logical control is now transferred to the operational block 223 where it is determined if the system is in heating mode or cooling mode. If the system is in cooling mode and the measured temperature is higher than the set temperature as measured by the operational block 225, the cooling system is activated in the functional block 227. If the system is in heating mode and the measured temperature is higher than the set temperature as measured by the operational block 224, the heating system is activated in the functional block 226.

### Operation

The occupant of the home or building only needs to carry the remote control thermostat into a room where he spends most of the time. The thermostat will measure the ambient air temperature and will instruct the base unit to turn on the heating system or the cooling system if the measured temperature differs from the set temperature.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### ADDITIONAL EMBODIMENT

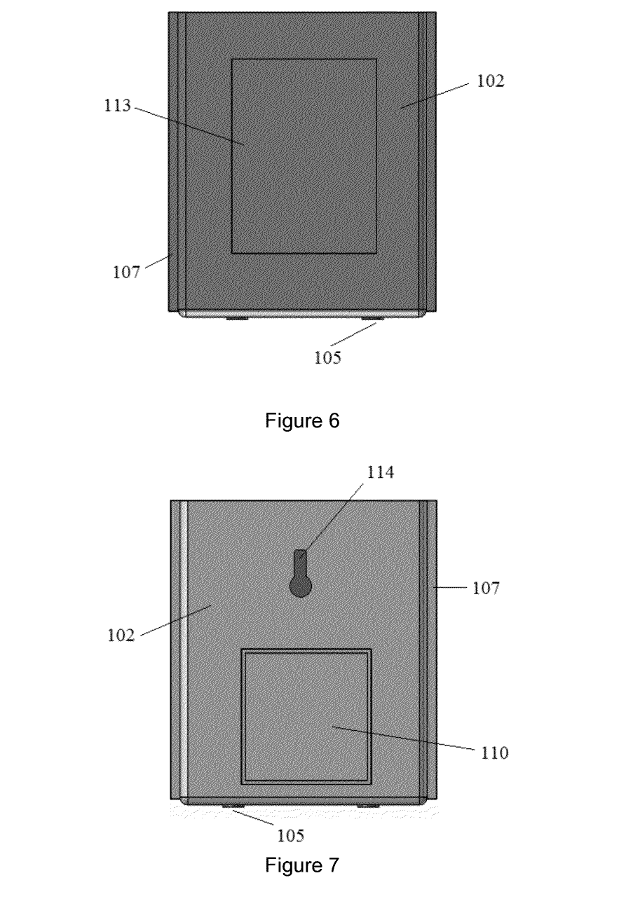

In accordance with the present invention, FIG. 6 describes an alternate embodiment where the keypad 106 and display 103 is replaced with a touch sensitive display 113.

FIG. 7 is a rear view of the remote control unit 102 showing the wall mount mechanism 114 so the remote control unit 102 can be mounted on the wall similar to a conventional thermostat.

### ALTERNATE EMBODIMENT

In the drawings and specification, there have been disclosed typical preferred embodiments or implementation of the invention and, although specific terms are employed, they are used in generic and descriptive sense only and not for the purposes of limiting the scope of the invention.

### ADVANTAGES

The present invention allows a homeowner or tenant to reposition the HVAC thermostat any where within his home or building without rewiring the system. The thermostat can be moved because the room is currently unoccupied or as a result of changes in décor and modifications of the room. This device helps conserve electricity by maintaining the comfort level where it is necessary.

### CONCLUSION, RAMIFICATION AND SCOPE

Accordingly, the reader will see that the portable digital thermostat allows the homeowner or tenant to reposition the HVAC thermostat based on occupancy. Furthermore, the portable digital thermostat has the additional advantages in that:
It permits the user to reposition the thermostat without rewiring the system. The base unit can be connected to the HVAC system using the existing wiring, identical to a conventional thermostat.
It offers full control of the thermostat from the remote control unit. The user has the ability to reprogram the thermostat as well as override settings remotely from anywhere within the building
It conserves energy by maintaining the comfort level where needed.
It uses conventional rechargeable batteries in the remote control unit that can be charged when the remote control unit is placed in the base or the charging station.
The remote control unit can be wall mounted like a conventional thermostat or placed on a flat surface such as a table.
It provides the ability to locate a lost or misplaced remote and also provide audible alerts if the unit cannot communicate wirelessly to the base units or if errors are detected in the HVAC system.

Although the description above contains much specificity, these should not be considered as limiting the scope of the embodiment but as merely providing illustrations of one of several embodiments. Thus the scope of the embodiment should be determined by the appended claims and legal equivalents, rather than the examples given.

What is claimed is:

1. Portable digital thermostat comprising:
a base unit that connects to the existing wiring and is installed at the same location as a conventional thermostat used to control a heating ventilation and air conditioning system;
a remote control unit that unit that can be placed anywhere in the building that measures and compares the ambient air temperature to the stored heating and cooling schedules and control the heating and cooling system by communicating wirelessly to the said base unit.

2. The portable digital thermostat of claim 1, wherein said remote control unit can be placed securely in the base unit or in a remote charging station to charge the conventional rechargeable batteries used within the remote control unit.

3. The portable digital thermostat of claim 1 wherein the base unit has a push button to locate a lost or misplaced remote control unit.

4. The portable digital thermostat of claim 1 wherein the remote control unit can be wall mounted or placed on a flat surface using the flip-up stand and has a buzzer to generate audible alerts.

5. The portable digital thermostat of claim 1 wherein the remote control unit can accept user selections via keypad or a touch sensitive display and will display the settings and the current environmental conditions on a display unit.

6. The portable digital thermostat of claim 1 wherein the base unit also displays the settings and the current environmental conditions on a display unit.

7. A portable digital thermostat controlling the heating, ventilation and air conditioning system to maintain the air temperature in a room that is used the most, without rewiring the system.

8. The portable digital thermostat conserves energy by controlling the comfort level in the room that is used the most.
